(19) United States
(12) Patent Application Publication
(10) Pub. No.: US 2015/0064412 A1
(43) Pub. Date: Mar. 5, 2015

(54) FABRIC STRUCTURE

(71) Applicant: Mackent Fabrics Co., Ltd., Taoyuan City (TW)

(72) Inventor: TAI -LI HSIAO, Taoyuan City (TW)

(73) Assignee: MACKENT FABRICS CO., LTD., Taoyuan City (TW)

(21) Appl. No.: 14/199,253

(22) Filed: Mar. 6, 2014

(30) Foreign Application Priority Data
Aug. 28, 2013 (TW) 102216195

(51) Int. Cl. B32B 3/28; B32B 5/26

(52) U.S. Cl. CPC B32B 3/28; B32B 5/26; B32B 2250/03; B32B 2250/20; B32B 2307/724; B32B 2437/00; B32B 2307/30; B32B 2307/726; B32B 2307/718
USPC 428/175

(57) ABSTRACT

An improved fabric structure includes an upper fabric layer, a middle fabric layer, and a lower fabric layer sequentially stacked together. The middle fabric layer has a wavy shape, and one of the upper and lower fabric layers is composed of 100% elastic fibers. Thanks to the properties of the elastic fibers, a garment made of the fabric structure is highly supportive and can lie in close contact with the wearer's skin,

### BACKGROUND OF THE INVENTION

1. Technical Field

The present invention relates to an improved fabric structure and, more particularly, to a novel fabric structure which enables a garment made thereof to be highly supportive and can lie in close contact with the wearer's skin.

2. Description of Related Art

People's requirements for the fabric structure of clothes are increasing. It is desirable that the fabric structure is breathable, effective in heat dissipation, sweat absorbent, comfortable, and lightweight. Consequently, a variety of weaving methods, fiber materials, and fiber arrangements for the fabric structure of garments were developed.

Take brassieres for example. It is generally required that a bra provides sufficient support for the breasts and will not slip easily. When it comes to bras without shoulder straps, it is further required that such a bra is in close contact with the wearer's skin and will stay where it is supposed to be without slipping; otherwise, the wearer is subject to the embarrassment of having the bra shifted in position.

However, the fabric structure of the commercially available spacer fabrics (also known as 3D fabrics or sandwich fabrics) fails to meet the aforesaid requirements and therefore needs improving.

### BRIEF SUMMARY OF THE INVENTION

The present invention provides an improved fabric structure which includes an upper fabric layer, a middle fabric layer, and a lower fabric layer sequentially stacked together. The middle fabric layer has a corrugated shape, and one of the upper and lower fabric layers is composed of 100% elastic fibers.

As one of the upper and lower fabric layers of the fabric structure is composed of 100% elastic fibers, the properties of the elastic fibers such as strechability, elastic recovery, softness, and a slight degree of adhesiveness can render a garment made of the fabric structure highly supportive and capable of lying in close contact with the wearer's skin.

### BRIEF DESCRIPTION OF THE SEVERAL VIEWS OF THE DRAWINGS

The structure and advantages of the present invention will be best understood by referring to the following detailed description of an illustrative embodiment in conjunction with the accompanying drawings, in which:

FIG. 1 is a perspective view of a preferred embodiment of the present invention; and

FIG. 2 schematically shows an application of the preferred embodiment depicted in FIG. 1.

### DETAILED DESCRIPTION OF THE INVENTION

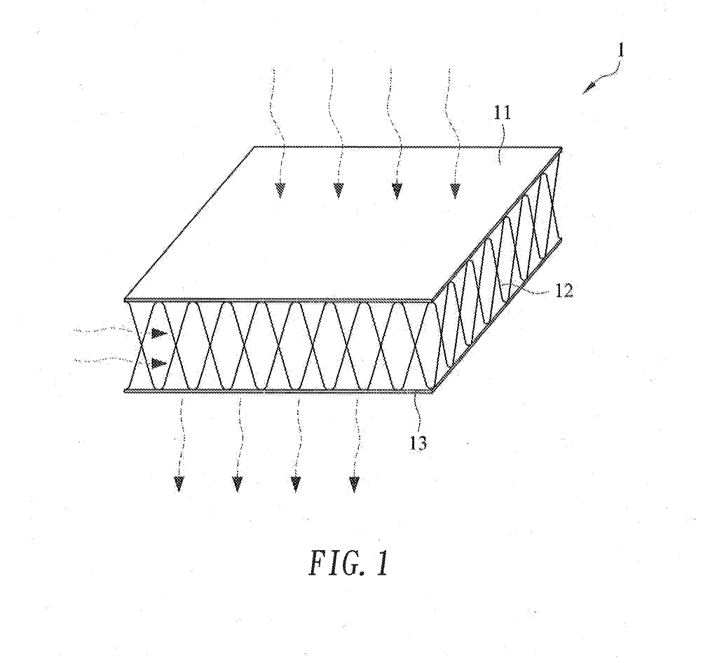

Please refer to FIG. 1 for a perspective view of a preferred embodiment of the present invention.

As shown in FIG. 1, the fabric structure 1 includes an upper fabric layer 11, a middle fabric layer 12, and a lower fabric layer 13 sequentially stacked together.

In other words, the fabric structure 1 includes three fabric layers arranged in a three-dimensional manner and is therefore a so-called spacer fabric or sandwich fabric.

As shown in FIG. 1, the middle fabric layer 12 is of a corrugated shape. In addition, one of the upper fabric layer 11 and the lower fabric layer 13 is composed of 100% elastic fibers. In this embodiment, the lower fabric layer 13 is composed of 100% elastic, fibers. It is understood, however, that the upper fabric layer 11 instead may be composed of 100% elastic fibers.

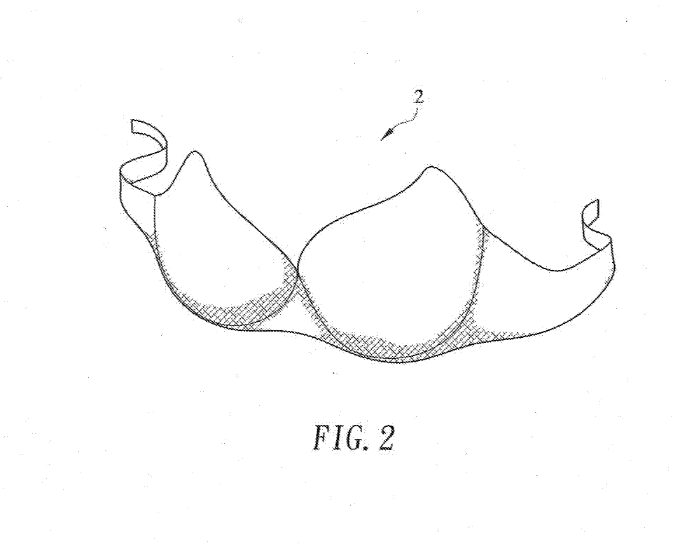

FIG. 2 is a schematic drawing showing an application of the preferred embodiment of the present invention.

More specifically, the bra 2 in FIG. 2 is formed of the fabric structure 1 shown in FIG. 1.

When the bra 2 in FIG. 2 is worn, the corrugated middle fabric layer 12 provides good permeability whereby moisture and air (heat) can pass through the bra 2, as indicated by the arrows in FIG. 1.

Moreover, with the lower fabric layer 13 being composed of 100% elastic fibers and in contact with the wearer's skin, the properties of the elastic fibers such as stretchability, elastic recovery, softness, and a small degree of adhesiveness enable the bra 2 formed of the fabric structure 1 to provide sufficient support for the breasts. The slight adhesiveness also allows the bra 2 to attach to the skin without slipping. Thus, the bra 2 is highly supportive and can lie in close contact with the wearer's skin.

What is claimed is:

1. A fabric structure, comprising an upper fabric layer, a middle fabric layer, and a lower fabric layer sequentially stacked together, wherein the middle fabric layer is of a corrugated shape, and one of the upper fabric layer and the lower fabric layer is composed of 100% elastic fibers.
